(19) United States
(12) Patent Application Publication
(10) Pub. No.: US 2023/0064450 A1
(43) Pub. Date: Mar. 2, 2023

(54) Infrared And Color-Enhanced Partial Image Blending

(71) Applicant: Ford Global Technologies, LLC, Dearborn, MI (US)

(72) Inventors: David Hiskens, Ann Arbor, MI (US); Collin Hurley, Canton, MI (US); Mark Gehrke, Ypsilanti, MI (US); Jonathan Diedrich, Carleton, MI (US)

(73) Assignee: Ford Global Technologies, LLC, Dearborn, MI (US)

(21) Appl. No.: 17/460,191

(22) Filed: Aug. 28, 2021

(51) Int. Cl. G06T 11/00; G06K 9/62; G06T 7/194; G06K 9/00

(52) U.S. Cl. CPC G06T 11/00; G06K 9/6232; G06T 7/194; G06K 9/00791; G06K 9/6201; G06T 2207/10048; G06T 2207/10024; G06T 2207/30252

(57) ABSTRACT

First objects are detected in an infrared image from an infrared camera and second objects are detected in a color image from a color camera. The first objects are compared with the second objects to determine pairs of matching first objects and second objects. For each matching pair, a respective region of an output image is colorized by setting colors of pixels in the region based on colors of the pixels of the second object in the matching pair. The pixels in the region have locations corresponding to the locations of the pixels in the first object of the matching pair. When the colorizing is complete, pixels not in the colorized regions have intensities of the infrared image. The output image is a version of the infrared image with a region colorized according to the color image.

### BACKGROUND

Infrared cameras are becoming popular for use in augmented reality and vehicle display systems because infrared cameras see better than color cameras in conditions such as nighttime, fog, mist, inclement weather, and smoke. Furthermore, infrared cameras are robust to high dynamic range situations such as solar blinding, headlight blinding, and entering/exiting tunnels. However, because infrared cameras do not sense the full visible spectrum of color their outputs typically lack color for features that may be desirable to see when displayed on a vehicle display intended for a driver. For example, brake lights, traffic lights, traffic signs, and street signs may not be apparent when only infrared video is displayed. Furthermore, feature detection algorithms may not be able to detect these types of features in infrared video. Although the presence of a feature such as a brake light structure might be visible and detectable, it is difficult to see (or computationally determine) whether the brake light is emitting red light. Such an omission can potentially mislead a driver or an augmented reality system to think that a brake light or red traffic light is not lit when in fact it is.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 shows an overview of feature-based partial image blending, in accordance with one or more example embodiments of the disclosure.

FIG. 2 shows a system and dataflow for displaying partially blended video, in accordance with one or more example embodiments of the disclosure.

FIG. 3 shows details of feature extraction and matching, in accordance with one or more example embodiments of the disclosure.

FIG. 4 shows a process for partial image blending, in accordance with one or more example embodiments of the disclosure.

FIG. 5 shows a computing device, in accordance with one or more example embodiments of the disclosure.

### DETAILED DESCRIPTION

### Overview

The following introduces some concepts discussed herein. In an embodiment of this disclosure, first objects are detected in an infrared image from an infrared camera and second objects are detected in a color image from a color camera. The first objects are compared with the second objects to determine pairs of matching first objects and second objects. For each matching pair, a respective region of an output image is colorized by setting colors of pixels in the region based on colors of the pixels of the second object in the matching pair. The pixels in the region may have locations corresponding to the locations of the pixels in the first object of the matching pair. When the colorizing is complete, pixels not in the colorized regions have intensities of the infrared image. The output image is a version of the infrared image with regions colorized according to the color image.

### Embodiments

One way to overcome some of the limitations of infrared video discussed in the Background is to blend the images (video frames) from a color camera and an infrared camera. Such blending often uses a geometric technique, where the infrared camera and color camera are calibrated to a same plane and a perspective transform is applied to align the infrared and color images. Then, coincident pixels from each image are blended to form a single image. To minimize artifacts such as foreground-object ghosting the cameras should be as close as possible to minimize parallax. However, this may not be possible for some applications. For example, vehicle design, production methods, and aesthetic considerations may limit how closely the cameras may be located to each other. For many applications, it may be desirable to allow the cameras to be widely separated, which precludes use of full-image blending. Techniques for feature-based partial image blending that are robust against camera arrangement parallax are described below.

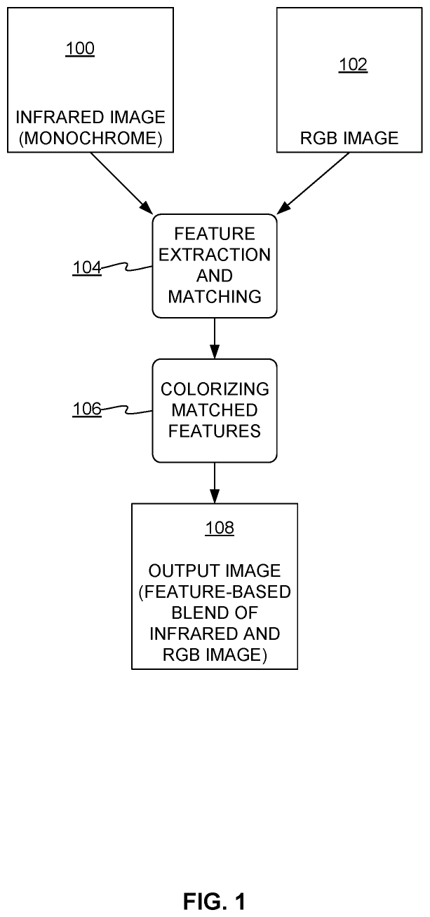

FIG. 1 shows an overview of feature-based partial image blending in accordance with one or more embodiments of the disclosure. An infrared image 100 and an RGB (red-green-blue) image 102 are received from an infrared camera and an RGB camera, respectively. The infrared image 100 and the RGB image 102 are passed to a feature extraction and matching module 104. The feature extraction and matching module 104 applies various feature detection and/or recognition algorithms on the images. The algorithms may be known image processing algorithms (e.g., object detection/recognition algorithms), possibly tailored to the specific types of objects intended to be recognized. The feature extraction and matching module 104 finds a first set of features and (possibly) their locations in the infrared image 100 and a second set of features and their locations in the RGB image 102. The first set of features and the second set of features are compared with each other to find matching features. Indications of the matched features are passed to a colorizing module 106.

The colorizing module 106 receives the indications of the matched features. The colorizing module 106 also receives an initial color image version of the infrared image 100, e.g., a grayscale image whose pixels have intensities of the pixels in the infrared image 100. According to the indications of the matched features, the grayscale color image is partially colorized at least at locations corresponding to the locations of the matched first features from the infrared image, thus producing a color output image 108. The colors of the features in the color output image 108 may be set based on the colors of the matched second features from the RGB image 102 (for example, an output image 108 color may be set according to a color of a matched second feature). The output image 108 may be shown on a display or provided to another module for further processing or analysis. The display may be in the operating area of a vehicle (of any type, e.g., an aircraft, automobile, boat, cart, etc.), thus providing the operator with the penetrating vision of the infrared camera and with select features colorized as informed by the RGB camera.

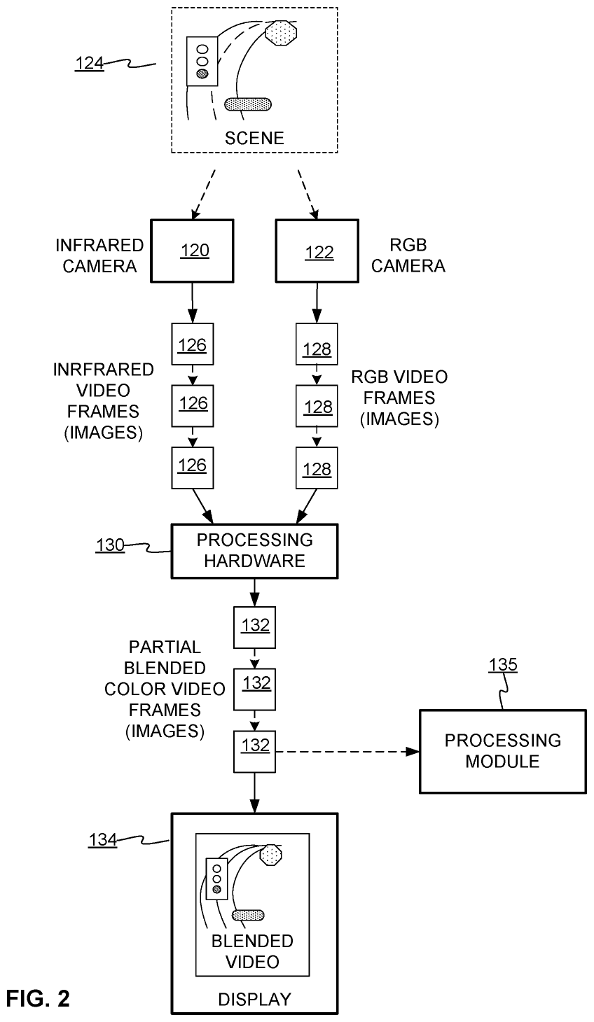

FIG. 2 shows a system and dataflow for generating partially blended video in accordance with one or more embodiments of the disclosure. The system may be incorporated in a vehicle such as an automobile, aircraft, boat, cart, or the like. The system includes an infrared camera 120 and an RGB camera 122. The infrared camera 120 may be any camera capable of sensing within a wavelength range of electromagnetic radiation suitable for sensing thermal radiation. For instance, the infrared camera may sense in the near infrared range, the short-wave infrared range, the mid-wave infrared range, the long-wave infrared range, or the far infrared range. That is, the infrared camera should be capable of sensing in low-light conditions and through obscuring conditions such as aerosols, fog, mist, and so forth. An infrared camera in the far-infrared range may be desirable for certain applications. The RGB camera 122 may be any color camera suitable for the particular application. In one embodiment, the infrared camera 120 and the RGB camera 122 may be within a single unit having one set of optics and a light splitter that splits light from the optics to an infrared sensor and an RGB sensor(s). In another embodiment, the infrared camera 120 may be an RGB-capable camera but with settings tuned to allow de facto infrared sensing. In the case of a color camera and an infrared camera with separate enclosures, because parallax should not be an issue for the colorization embodiments described herein, the cameras need not be close to each other.

The infrared camera 120 outputs a stream of infrared video frames/images 126, and the RGB camera 122 outputs a stream of RGB video frames/images 128. The video streams are fed to processing hardware 130. The processing hardware 130 may be a single general-purpose processor or a collection of cooperating processors such as a general-purpose processor, a digital signal processor, a vector processor, a neural network chip, a field-programmable gate array, a custom fabricated chip hardwired to perform the relevant steps and algorithms, etc. The processing hardware 130 may also be a component of a known type of augmented reality engine, modified as needed. If a robust augmented reality engine is available, the augmented reality engine may be provided with additional programming to implement the embodiments described herein. The processing hardware 130 may also have storage such as buffers to store incoming and outgoing video frames, memory for storing instructions, and so forth. A programmer of ordinary skill can readily translate the details herein into code executable by the processing hardware 130.

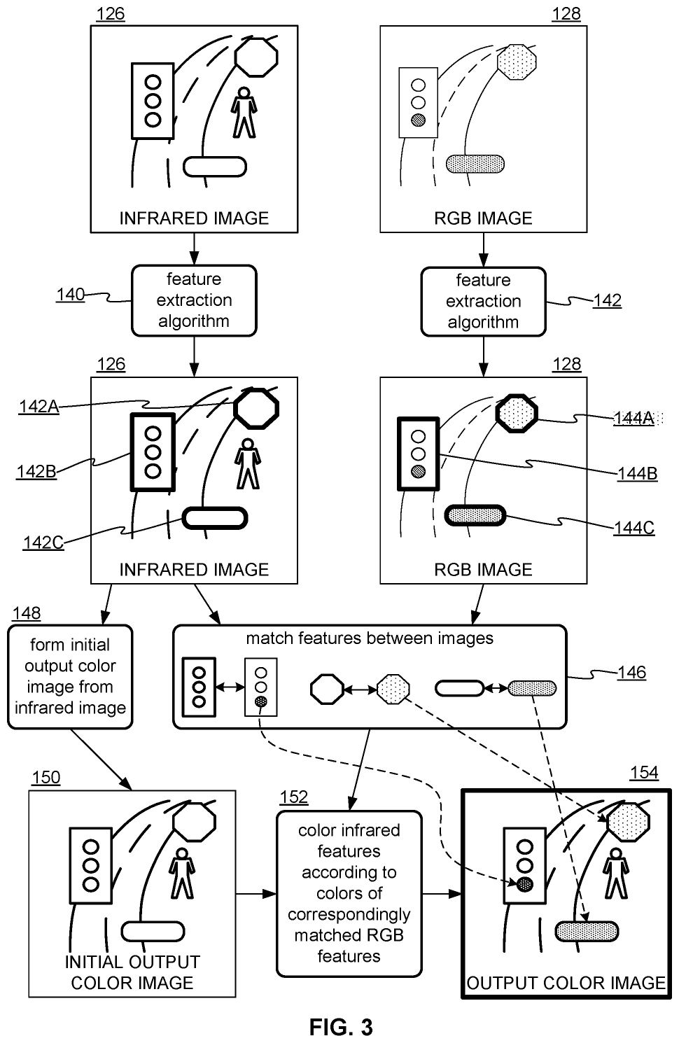

To allow comparison between infrared images 126 and RGB images 128, the processing hardware 130 may need to match the rate of frames being processed. For instance, if one camera has a higher frame rate then some if its frames may need to be dropped. As discussed with reference to FIG. 3, pre-processing such as non-uniformity correction, filters, etc. may need to be applied to the images before feature extraction is performed. When a pair of concurrently captured infrared and RGB images have been pre-processed, one or both images may be cropped or resized so that the images have the same size. Geometric transforms may be applied to either or both images to make the images the same size or to partly account for parallax (i.e., to make the images somewhat co-planar), which will be specific to the arrangement of the cameras. Image resizing may instead be incorporated into the geometric transforms.

When a pair of infrared and RGB images have been rendered into comparable forms, features are extracted from the images. In most cases, a different feature extraction algorithm will be used for each image type. As noted, the feature extraction algorithms may be stock algorithms, perhaps tuned to the particular hardware and types of features to be recognized. Although feature extraction is described herein with reference to a single RGB image and a single infrared image, the image analysis (feature detection) may involve temporal (inter-frame) analysis as well as intra-frame analysis. Moreover, feature matching may only need to be done on a ratio of available images. For example, if sixty frames per second are available, features might be extracted once every 10 frames, and the corresponding feature coloring might be kept stationary in the displayed images between feature-matching and colorization iterations. As discussed below, the output color images are generated based on matching features from an infrared image with features from an RGB image.

The partially blended color images 132 are provided to a display adapter/driver which displays the outputted images on a display 134 (as used herein, “partially blended” refers to an image that has some pixel values based on the RGB image and some pixel values based on the infrared image). The partially blended color images 132 may include mostly grayscale image data (in particular, background scenery based on data from the infrared camera 120), while features of interest may be shown colorized (based on data from the RGB camera 122) to provide the user with more information about conditions in front of the cameras. For example, if the system is implemented in a vehicle, and if there is a stop light (or a runway light) in the captured scene, where the ambient conditions are foggy, then a partially blended color image will provide the driver or autonomous controls of the vehicle the clarity of objects in the scene via the infrared camera 120 and the color of the currently lit stop light via the RGB camera 122, which partially blended color image may be shown on a display 134 of the vehicle. If a brakelight of a vehicle in the scene is currently lit (emitting red light per the RGB camera), the brake lights maybe be feature-matched between the IR and color images 126, 128, and the red of the brake lights may be rendered on the IR image 126 to generate a partially bended color image that may be shown on the display 134 so that the driver or autonomous controller of the vehicle knows a vehicle in front is braking or stopped. Because the bulk of the displayed video is supplied by the infrared camera (and possibly all of the pixel intensities), conditions such as rapid light changes, glare, and oncoming headlights will be minimized. In other embodiments, as discussed below, in addition to or alternatively to displaying the partially blended color images 132, the partially blended color images 132 may be sent to a processing module 135. The processing module 135 might be an autonomous driving system, an image processing algorithm, or the like.

FIG. 3 shows details of feature extraction and matching in accordance with one or more embodiments of the disclosure. As discussed above, an infrared image 126 and an RGB image 128 are received from the respective cameras and any preferred pre-processing or image alignment may be performed to prepare the images for feature extraction and comparison. A first feature extraction algorithm 140 receives the infrared image 126 and a second feature extraction algorithm 142 receives the RGB image 128. The feature extraction algorithms may perform object detection and possibly also object recognition. If only object detection is performed, objects may be detected using background/foreground segmentation, for example, among other techniques. In either case, the locations of the features are captured. The features may be delineated using bounding boxes or they may be segmented as well-outlined regions matching the profiles of the corresponding objects in the captured scene. As noted above, the feature extraction may be performed using a machine learning algorithm such as a convolutional neural network, depending on the processing capacity that is available. Machine learning is suitable for both object detection, recognition, and segmentation. In one embodiment, extracted features may be filtered to isolate features of likely significance, such as features that are emitting light (in particular red light), objects with outlines or locations sufficiently fitting patterns of road signs, objects within a certain distance (according to parallax), or objects in motion, for example.

In the example shown in FIG. 3, the first feature extraction algorithm 140 extracts and outputs a first feature set that includes a stop sign 142A, a traffic light 142B, and a brakelight 142C, as well as locations of their profiles (or bounding boxes) in the infrared image 126. The second feature extraction algorithm 142 extracts and outputs a second feature set, which also includes a stop sign 144A, a traffic light 142B, and a brakelight 142C, albeit from the RGB image 128. As discussed below, each feature may be tagged with multiple attributes for comparison. In practice, each algorithm will likely output features not found by the other. For example, the first feature extraction algorithm 140 may detect a person that is not detected by the second feature extraction algorithm or that is not even present in the RGB image 128. The first features 142A-142C from the infrared image 126 (and optionally their locations) and the second features 144A-144C (and optionally their locations) from the RGB image 128 are passed to a feature-matching module 146.

The feature-matching module 146 compares features in the first feature set with the features in the second feature set to find matches. The comparing may involve comparing a number of attributes of each feature. Such attributes may include tagged object types (as per previous object recognition), probability of accuracy, location, etc. Comparing may additionally or alternatively be based on shape similarity. Comparing may be as simple as comparing locations. In one embodiment each potential match may be scored as a weighted combination of matching attributes. Inter-frame analysis may also be used to inform the feature comparing. For instance, preceding matches may inform future potential matches. If many features are expected and the feature-comparing is computation intensive, then features may be divided into subsets in image regions and only features within a given subset are cross-compared. Another approach is to only compare features within a certain distance of each other (with possible uncorrected parallax considered). Pairs of sufficiently matching features (those above a matching score threshold) are passed to a colorizing module 152.

An image-generating module 148 may produce a color version of the infrared image 126, which is an initial output color image 150 to be partially colorized by the colorizing module 152. Because infrared cameras output grayscale images whose pixels only have intensity values, a monochromatic color version is produced which, although initially may only have shades of gray, may have per-pixel color information. It may be convenient for the initial output color image 150 to be an HSV (hue-saturation-value) image. The values of each pixel are set according to the intensities of the corresponding pixels in the infrared image 126. In another embodiment, the initial output color image 150 is an RGB image and each pixel's three color values are set to the intensity of the corresponding pixel in the infrared image 126, thus producing a grayscale image mirroring the infrared image 126 yet amenable to changing the colors of its pixels. If the infrared camera outputs RGB or HSV images then the function of the image-generating module may be omitted and the infrared image 126 is passed to the colorizing module 152 for colorization. Color representations other than HSV may be used. For example, the hue-saturation-lightness representation may be used.

The colorizing module 152 receives the initial output color image 150 and the matched features from the feature-matching module 146. Because the initial output color image 150 and the infrared image 126 correspond pixel-by-pixel, the locations and pixels of the matched features from the infrared image are the same in the initial output color image 150. In one embodiment, the colorizing module 152 colors each matched feature (from the infrared image) in the initial output color image 150 based on the corresponding colors of the matching features from the RGB image 128. Colors may be copied pixel-by pixel from an RGB feature, or an average color or hue of the matching RGB feature may be used, for example. Colorized features may also be made brighter, may have their saturation adjusted, or may be enhanced in other ways that make the color of the feature easier to perceive. In another embodiment, pre-defined colors may be used based on the colors in the RGB feature and/or based on the type of feature (e.g., a lit stoplight or a stop sign). In yet another embodiment the features may be replaced with pre-stored images. For instance, the actual imagery of a stop sign may be replaced with an appropriately scaled pre-stored color stop sign bitmap, giving the appearance of an overlay. In another embodiment, a pre-defined mapping of the average colors to single colors is provided. Average colors of respective RGB features are mapped to the single colors as indicated by the map and the features in the initial output color image 150 are colored accordingly. Moreover, because an RGB image is available, known coloring algorithms may be used to generally colorize other portions of the initial output color image 150. When the matching features have been colorized, the colorizing module 146 outputs an output color image 154 for display. Portions of the output color image 154 other than the colorized features/regions may remain gray with intensities of the pixels in the infrared image 126. The features/regions in the output color imager 154 corresponding to the matched features from the infrared image 126 have colors based on the matched feature from the RGB image 128, and in particular, they may have colors that correspond to the colors of the matched features from the RGB image 128.

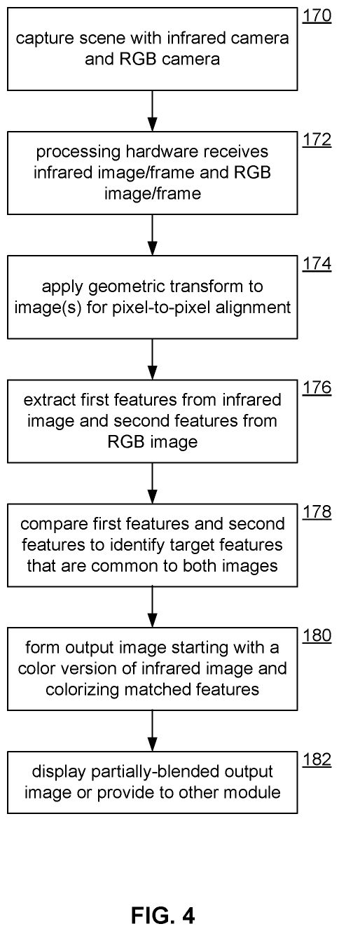

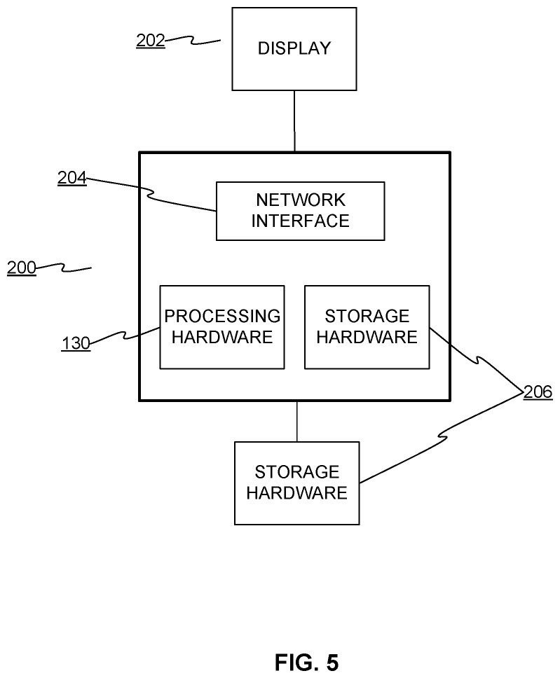

FIG. 4 shows a process for partial image blending in accordance with one or more embodiments of the disclosure. The process may be performed by the processing hardware 130, which may be an on-board computer of a vehicle, as discussed with reference to FIG. 5. At step 170 a scene is captured by the infrared camera and the RGB camera. The cameras need not be located close to each other. At step 172 the processing hardware receives the infrared and color images from the respective cameras and performs any image pre-processing that might be helpful. At step 174 a geometric transform is optionally performed on either or both images so that they are co-planar and mostly aligned pixel-by-pixel with respect to the captured scene. At step 176 first features are extracted from the infrared image and second features are extracted from the RGB image. At step 178 the first features are compared to the second features to find matching pairs of infrared and RGB features. At step 180 the output image is initially formed as a color version of the infrared image. Portions of the initial output image that correspond to the respective pairs of matching features are colorized based on their matching RGB features. At step 182 the output image is displayed and/or passed to another module for further processing.

While the embodiments described above are useful for providing video output that conveys a blend of infrared and RGB information to a user, the output of the partial blending techniques, whether displayed or not, can also be useful for informing various levels of autonomous control of a vehicle. For instance, an automatic braking feature can use the same partially blended video output for decision making. Moreover, while the video output is useful for an operator, the video need not be displayed within a vehicle. The video may be displayed at a terminal or remote control that is separate from the vehicle.

While the embodiments above have computing modules performing various respective functions, the modules are arbitrary units of convenience; the functionality of the modules may be distributed across other modular arrangements.

FIG. 5 shows details of a computing device 200, one or more of which may execute features discussed above. The technical disclosures herein will suffice for programmers to write software, and/or configure reconfigurable processing hardware (e.g., field-programmable gate arrays (FPGAs)), and/or design application-specific integrated circuits (ASICs), etc., to run on the computing device 200 to implement any of the features or embodiments described herein.

The computing device 200 may have one or more displays 202, a network interface 204 (or several), as well as storage hardware 206 and processing hardware 130, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 206 may be any combination of magnetic storage, static memory, volatile memory, non-volatile memory, optically or magnetically readable matter, etc. The meaning of the term “computer-readable storage”, as used herein does not refer to signals or energy per se, but rather refers to physical apparatuses and states of matter. The hardware elements of the computing device 200 may cooperate in ways well understood in the art of machine computing. In addition, input devices may be integrated with or in communication with the computing device 200. The computing device 200 may have any form-factor or may be used in any type of encompassing device. The components of the computing device 200 may vary in number and some may not be present, for example the network interface 204 and the display 202.

As used in this application, the terms “environment,” “system,” “unit,” “module,” “architecture,” “interface,” “component,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still, in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, permit the automated provision of an update for a vehicle profile package. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. An apparatus comprising:
an infrared camera outputting infrared images of a scene;
a color camera outputting color images of the scene;
processing hardware configured to:
receive an infrared image from the infrared camera and a color image from the color camera;
extract a first feature from the infrared image;
extract a second feature from the color image;
determine a match between the first feature from the infrared image and the second feature from the color image; and
generate an output image, wherein at least some pixels of the output image comprise respective colors that are set according to intensities of corresponding pixels in the infrared image, and wherein colors of at least some pixels in a region of the output image that corresponds to the first feature are set according to the match between the first feature and the second feature; and
a display configured to display the output color image.

2. The apparatus according to claim 1, wherein the first feature is segmented from background of the scene and comprise an outline of a respective foreground object captured in the scene.

3. The apparatus according to claim 1, wherein the output color image initially comprises a hue-saturation-value (HSV) image whose values are initially set according to intensities of corresponding pixels in the infrared image, wherein the colors of the pixels in the region are set by setting their respective hues according to the color in the second feature, and wherein the HSV image is converted to a red-blue-green (RGB) image before being displayed by the display.

4. The apparatus according to claim 1, wherein the apparatus is incorporated in a vehicle.

5. The apparatus according to claim 1, wherein the extracting the first feature and extracting the second feature includes recognizing corresponding objects in the scene, and wherein the matching is based at least in part on the recognition of the objects.

6. The apparatus according to claim 5, wherein the colors of the pixels in the region are based at least in part on a type of a recognized object that corresponds to the first feature or the second feature.

7. The apparatus according to claim 1, wherein the extraction of the first features and the extraction of the second features is performed by one or more machine learning algorithms.

8. The apparatus according to claim 1, wherein the processing hardware to perform a geometric transform on a grayscale infrared image or the color image in correspondence with parallax between the infrared camera and the color camera.

9. A method performed by a computing device comprising storage hardware and processing hardware, the method comprising:
receiving an infrared image of a scene from an infrared camera;
detecting a first set of objects in the infrared image;
receiving a color image of the scene from a color camera;
detecting a second set of objects in the color image;
determining one-to-one matches between first objects in the first set of objects and second objects in the second set of objects;
based on the determined one-to-one matches between the first objects and the second objects, generating an output color image by setting colors, of pixels in the output color image at regions corresponding to the matched first objects, to colors based on colors of the correspondingly matching second objects, wherein pixels in the output color image not in the colorized regions have intensities based on corresponding pixels in the infrared image; and
displaying the output color image.

10. The method according to claim 9, wherein the pixels in the output color image not in the colorized regions have gray colors.

11. The method according to claim 9, wherein the pixels in the regions have intensities according to corresponding pixels in the matched first objects.

12. The method according to claim 9, wherein the infrared image comprises pixels each having respective color values, and wherein the output color image comprises the infrared image modified by setting the colors of the pixels in the regions based on the colors of the matched second objects.

13. The method according to claim 9, further comprising generating the output color image by instantiating the output color image as a color image version of the infrared image such that colors of the pixels in the output color image are initially set to grayscale colors with intensities corresponding intensities of respective pixels in the infrared image.

14. The method according to claim 9, wherein the detecting the first set of objects in the infrared image comprises determining first sets of features for the respective objects in the first set of objects, wherein the detecting the second set of objects in the color image comprises determining second sets of features for the respective objects in the second set of objects, and wherein the determining the one-to-one matches between the first objects and the second objects comprises comparing the first sets of features with the second sets of features.

15. The method according to claim 9, further comprising geometrically transforming the infrared image or the color image to compensate for parallax between the infrared camera and the color camera.

16. Computer-readable storage hardware storing instructions configured to cause processing hardware to perform a process, the process comprising:
performing first object detection on a first image to detect a first object in the first image, the first image provided by an infrared camera;
performing second object detection on a second image to detect a second object in the second image, the second image provided by an RGB camera;
determining a match between the first objects and the second object;
based on the determining the match, colorizing a region of an output image by setting colors of pixels in the region based on colors of the pixels of the second object, and wherein the pixels in the region correspond to the first object, wherein when the colorizing is complete the output image comprises the pixels in the colorized region and pixels not in the colorized region, the pixels not in the colorized regions having intensities based on corresponding pixels of the infrared image; and
displaying the output image;

17. Computer-readable storage hardware according to claim 16, wherein the steps are repeated for different first images from the infrared camera and different second images from the RGB camera and the displaying the resulting output images comprise frames of displayed video.

18. Computer-readable storage hardware according to claim 16, further comprising adjusting intensities of pixels in the region based on intensities of pixels in the second objects.

19. Computer-readable storage hardware according to claim 16, wherein the output image comprises the infrared image but with the regions colorized therein.

20. Computer-readable storage hardware according to claim 16, wherein the computer-readable storage hardware and the computing hardware are incorporated in a vehicle.
